(19) United States
(12) Patent Application Publication
(10) Pub. No.: US 2020/0252520 A1
(43) Pub. Date: Aug. 6, 2020

(54) IMAGE FORMING SYSTEM, INFORMATION PROCESSING DEVICE, AND GROUP SETTING METHOD

(71) Applicant: KONICA MINOLTA, INC., Tokyo (JP)

(72) Inventor: Akito OTA, Toyokawa-shi (JP)

(73) Assignee: KONICA MINOLTA, INC., Tokyo (JP)

(21) Appl. No.: 16/736,138

(22) Filed: Jan. 7, 2020

(30) Foreign Application Priority Data
Jan. 31, 2019 (JP) 2019-015234

(51) Int. Cl. H04N 1/32; H04N 1/00

(52) U.S. Cl. CPC H04N 1/32523; H04N 2201/0094; H04N 1/00925; H04N 1/00408

(57) ABSTRACT

An image forming system includes: a first image forming device; a second image forming device; a third image forming device; and an information processing device, wherein the first image forming device saves document data, the second image forming device acquires a document list indicating document data to present and acquires the document data specified from the document list from the first image forming device to output, the third image forming device manages the first image forming device, the second image forming device, and the third image forming device as a group, and the information processing device selects the image forming device allowed to belong to a group from a floor map in which installation positions and device information of a plurality of image forming devices are registered, and associates the information on the selected image forming device with the group to register in the third image forming device.

The entire disclosure of Japanese patent Application No. 2019-015234, filed on Jan. 31, 2019, is incorporated herein by reference in its entirety.

### BACKGROUND

### Technological Field

The present invention relates to an image forming system including a plurality of image forming devices, an information processing device, and a group setting method, and especially relates to a method of setting a plurality of image forming devices in a group.

### Description of the Related Art

Conventionally, in a workplace with many employees, a plurality of image forming devices (also referred to as “MFPs”) is installed in a room, and the need to “print using an available image forming device” becomes apparent, so that there is an increasing need for ubiquitous printing that allows printing from any image forming device.

JP2015-125676 A discloses an information processing device capable of proposing an installation location of an image forming device according to a load situation of a user who uses the image forming device.

For example, in FIG. 1, a ubiquitous group is formed of three MFPs (ST, CL 1, and CL 2). In this specification, the ubiquitous group may be abbreviated as a “group”. Herein, a storage (ST) machine is an image forming device which receives an instruction (print job) from a terminal device used by the user and saves a document. A client (CL) machine is an image forming device which acquires the print job from the ST machine to output. First, a user A outputs the print job to the ST machine (1). When an MFP (CL 1) usually used by the user A is used by a user B, the user A moves to a nearby available MFP (CL 2) (2), and may output the print job (document) by using the destination MFP (CL 2) (3).

Construction of the group and a role (ST/CL) of each MFP as described above may be collectively set using a tool as illustrated in FIG. 2. In FIG. 2, a group registering screen 1002 is displayed by clicking “create group” on a setup screen 1001, and a new group may be created by a printer for which ubiquitous printing is not yet set. For example, on the group registering screen 1002, six of eight displayed printers (MFPs) are selected.

In the technology disclosed in JP 2013-270989 A, even if the image forming device is installed in a proposed arrangement position, a group to which the image forming device belongs and a group to which another image forming device around the same belongs might be different. Therefore, there is a problem that a user's document is saved in the image forming device (ST machine) of another group.

FIG. 3 illustrates a problem of a conventional group constructing method. When constructing the group, in a case where only a MFP device name and MFP IP are presented as illustrated in FIG. 3, it is not possible to know where the MFP is installed based only on that information, and a desired ubiquitous group cannot be constructed. For example, in a case where upper-half four printers (MFPs) out of eight printers presented on the setup screen 1001 are set as a group A and lower-half four printers are set as a group B, the MFPs the installation positions thereof are close to each other are constructed as different groups.

For example, the user wants to transmit the print job to an ST A machine in the group A and output the print job from an MFP (CL B-1) close to the ST A machine. However, the CL B-1 machine belongs to the group B, and the document transmit to the ST A machine cannot be output because the group is different. As described above, a problem that the user's document is saved in the ST machine of a different group and cannot be output only by a specific MFP (CL machine of the same group as the ST machine which saves the document) occurs.

Furthermore, depending on the setting, it is possible to acquire a document list on the ST machine of another group by the ST machine of its own group, but since different groups do not cooperate with each other, it takes more trouble than acquiring the document list in the ST machine of its own group. FIG. 4 illustrates an example of a conventional saved document list screen. In the example in FIG. 4, a tab “MyGroup123456789” is selected and a list of saved documents is displayed. When a tab of another group is selected, a list of saved documents of the other group is displayed.

### SUMMARY

Therefore, there is a demand for a method capable of easily constructing a group between image forming devices installed in close positions.

To achieve the abovementioned object, according to an aspect of the present invention, an image forming system reflecting one aspect of the present invention comprises: a first image forming device; a second image forming device; a third image forming device; and an information processing device, wherein the first image forming device saves document data, the second image forming device acquires a document list indicating document data to present and acquires the document data specified from the document list from the first image forming device to output, the third image forming device manages the first image forming device, the second image forming device, and the third image forming device as a group, and the information processing device selects the image forming device allowed to belong to a group from a floor map in which installation positions and device information of a plurality of image forming devices are registered, and associates the information on the selected image forming device with the group to register in the third image forming device.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a view illustrating an example of general ubiquitous printing;

FIG. 2 is a view illustrating an example of a conventional group constructing method;

FIG. 3 is a view illustrating a problem of the conventional group constructing method;

FIG. 4 is a view illustrating an example of a conventional saved document list screen;

FIG. 5 is a view illustrating a configuration example of an image forming system according to one embodiment of the present invention;

FIG. 6 is a view illustrating an example of a group configuration list according to one embodiment of the present invention;

FIG. 7 is a view illustrating an example of a saved document list screen according to one embodiment of the present invention;

FIG. 8 is a sequence diagram illustrating a general flow from document saving to output;

FIG. 9 is a view illustrating a network configuration example of the image forming system according to one embodiment of the present invention;

FIG. 10 is a view illustrating a group creating function in the image forming system according to one embodiment of the present invention;

FIG. 11 is a table illustrating a configuration example of floor map data according to one embodiment of the present invention;

FIG. 12 is a block diagram illustrating a configuration example of the image forming device according to one embodiment of the present invention;

FIG. 13 is a block diagram illustrating a configuration example of a terminal device according to one embodiment of the present invention;

FIG. 14 is a block diagram illustrating a configuration example of a management server according to one embodiment of the present invention;

FIG. 15 is a view illustrating an example of a group creating method in the image forming system according to one embodiment of the present invention;

FIG. 16 is a sequence diagram illustrating a procedure example of a group creating process according to one embodiment of the present invention;

FIG. 17 is a view illustrating a screen for setting a response in a case where there is a document acquisition request from the image forming device of another group according to one embodiment of the present invention;

FIG. 18 is a view illustrating an effect for each setting content in a case where there is the document acquisition request from the image forming device of the other group according to one embodiment of the present invention;

FIG. 19 is a flowchart illustrating a procedure example of a process by an ST machine in a case where there is the document acquisition request from the image forming device of the other group according to one embodiment of the present invention;

FIG. 20 is a view illustrating a screen for setting a response in a case where there is the document acquisition request from the image forming device a group to which this belongs is not yet set (group unset machine) according to one embodiment of the present invention;

FIG. 21 is a view illustrating a first method of adding the image forming device to the group in the image forming system according to one embodiment of the present invention;

FIG. 22 is a view illustrating a second method of adding the image forming device to the group in the image forming system according to one embodiment of the present invention;

FIG. 23 is a view illustrating a third method of adding the image forming device to the group in the image forming system according to one embodiment of the present invention;

FIG. 24 is a view illustrating a fourth method of adding the image forming device to the group in the image forming system according to one embodiment of the present invention;

FIG. 25 is a view illustrating a first screen example for checking a ubiquitous function assigned to the image forming device in the image forming system according to one embodiment of the present invention;

FIG. 26 is a view illustrating a second screen example for checking a ubiquitous function assigned to the image forming device in the image forming system according to one embodiment of the present invention;

FIG. 27 is a view illustrating a third screen example for checking a ubiquitous function assigned to the image forming device in the image forming system according to one embodiment of the present invention;

FIG. 28 is a view illustrating a first screen example for checking the image forming devices forming the group in the image forming system according to one embodiment of the present invention;

FIG. 29 is a view illustrating a second screen example for checking the image forming devices forming the group in the image forming system according to one embodiment of the present invention;

FIG. 30 is a view illustrating a first screen example for checking the ubiquitous function assigned to the image forming device in the image forming system according to one embodiment of the present invention;

FIG. 31 is a view illustrating a second screen example for checking the ubiquitous function assigned to the image forming device in the image forming system according to one embodiment of the present invention;

FIG. 32 is a view illustrating an example in which the ubiquitous function to be assigned to the image forming device is recommended in the image forming system according to one embodiment of the present invention;

FIG. 33 is a view illustrating an example of making an inquiry of the ubiquitous function to be assigned to the image forming device in the image forming system according to one embodiment of the present invention;

FIG. 34 is a view illustrating a first screen example for checking a group to which the image forming device displayed on a floor map belongs in the image forming system according to one embodiment of the present invention;

FIG. 35 is a view illustrating a second screen example for checking a group to which the image forming device displayed on a floor map belongs in the image forming system according to one embodiment of the present invention; and

FIG. 36 is a view illustrating an error screen indicating that a new image forming device cannot be registered in a group in a case where the number of image forming devices registered in the group reaches a predetermined number in the image forming system of one embodiment of the present invention.

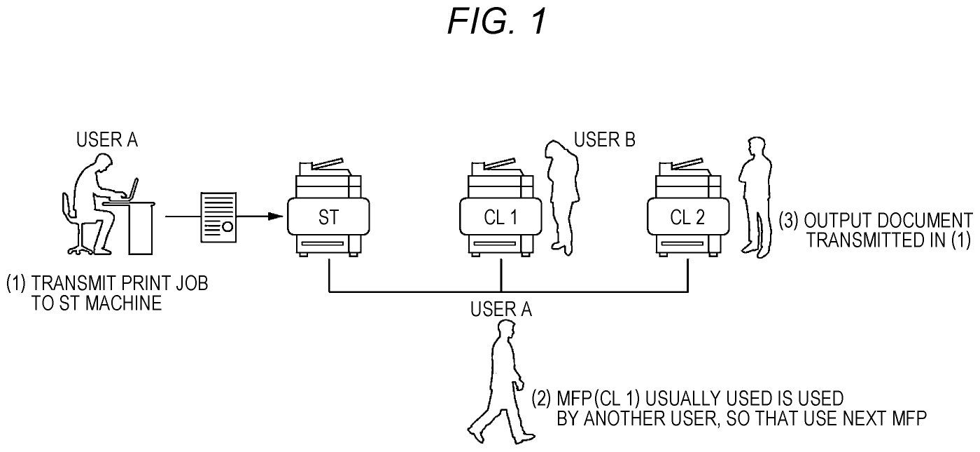

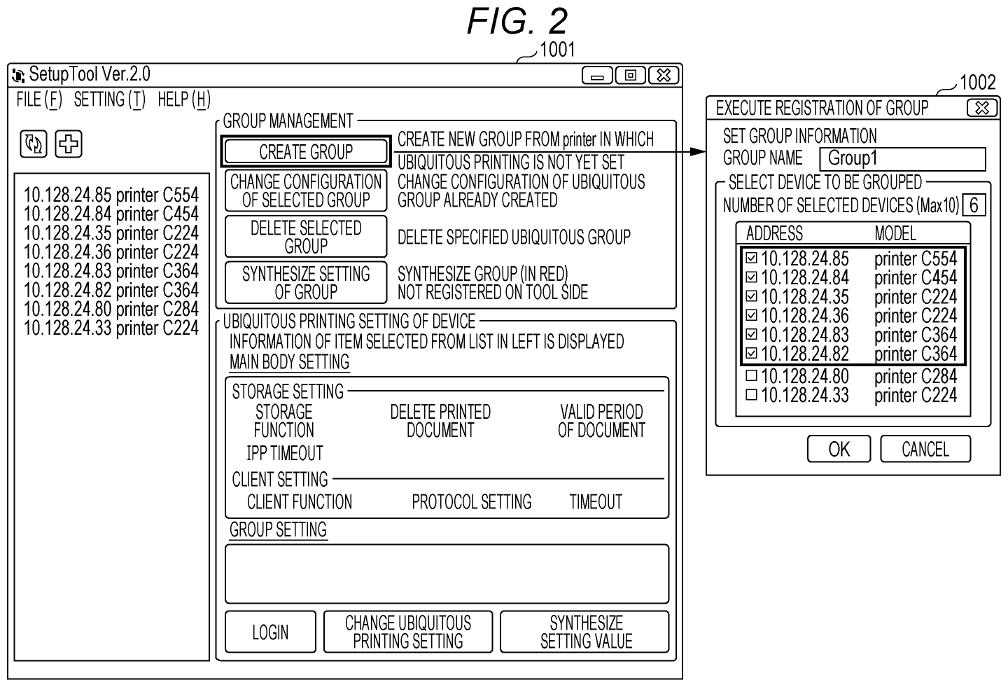

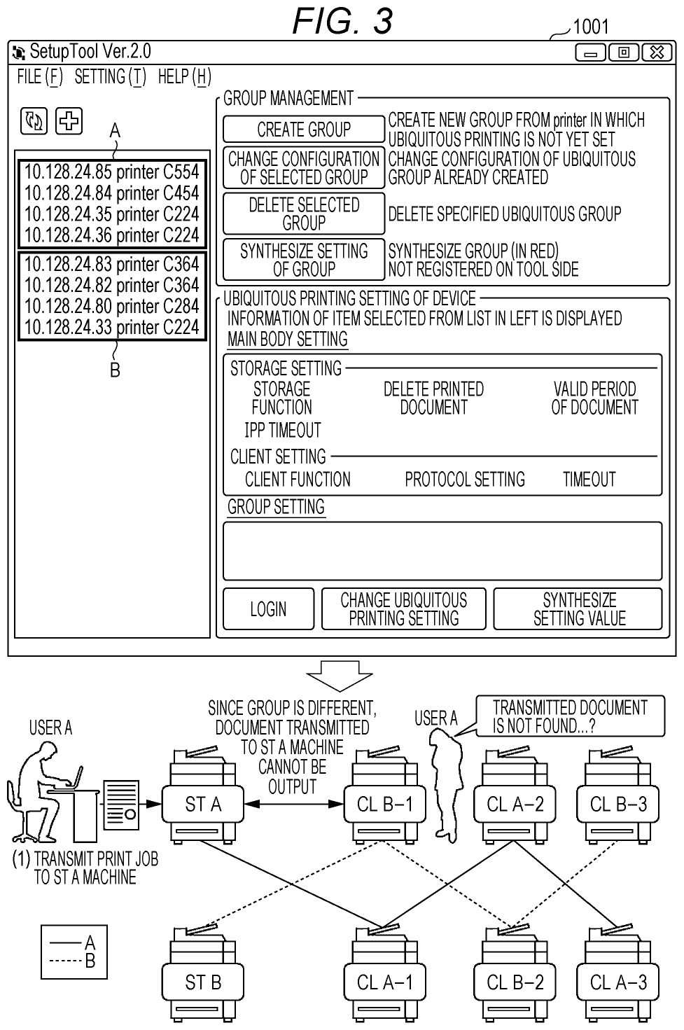

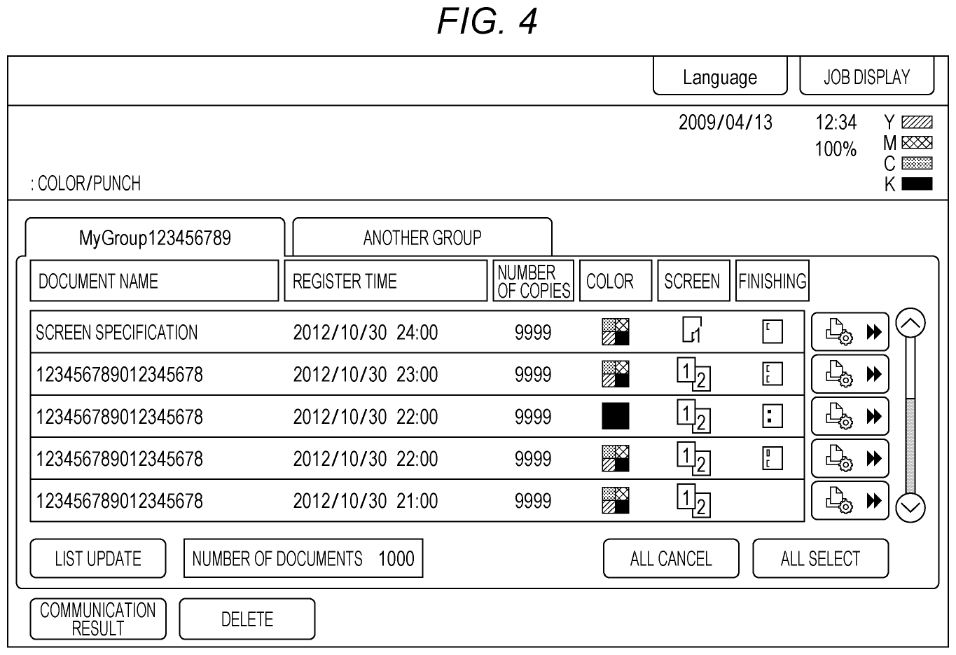

### DETAILED DESCRIPTION OF EMBODIMENTS

Hereinafter, one or more embodiments of the present invention will be described with reference to the drawings. However, the scope of the invention is not limited to the disclosed embodiments. In this specification and the accompanying drawings, components having substantially the same function or configuration are assigned with the same reference numerals, and the description thereof is not repeated.

[Configuration of Image Forming System]

First, an image forming system according to one embodiment of the present invention is described.

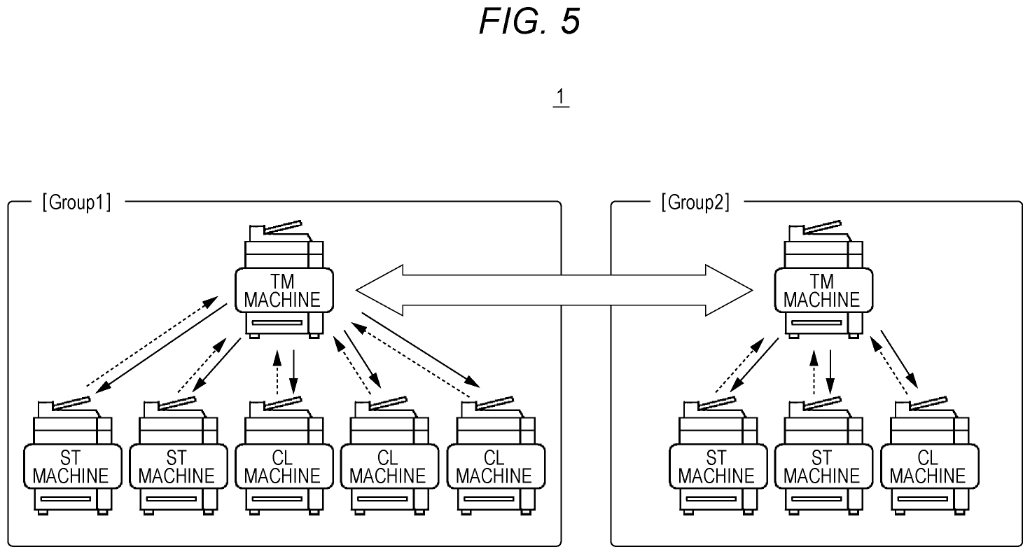

FIG. 5 illustrates a configuration example of the image forming system according to one embodiment of the present invention. In an image forming system 1 illustrated in FIG. 5, two ubiquitous groups (hereinafter “groups”) are constructed, and each group includes a plurality of image forming devices. A group 1 includes two ST machines and three CL machines with one topology manager (TM) machine at the top. A group 2 includes two ST machines and one CL machine with one TM machine at the top.

In this embodiment, the ST machine corresponds to a first image forming device, the CL machine corresponds to a second image forming device, and the TM machine corresponds to a third image forming device. Note that the ST machine may also serve as the CL machine.

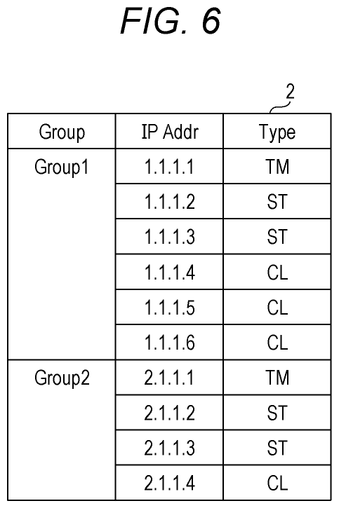

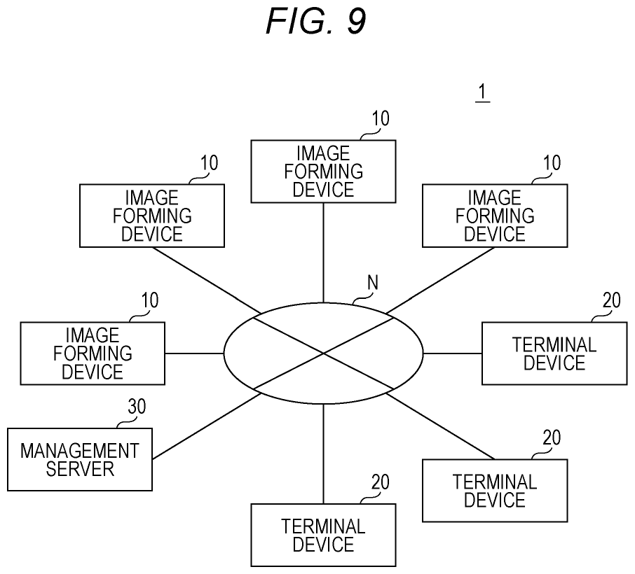

One TM machine is installed in each group as an image forming device which manages a group configuration list (refer to FIG. 6) to be described later. The TM machine receives the group configuration list from a management server 30 (refer to FIG. 9) to be described later. The TM machines of different groups are configured to be able to communicate with each other. Each of the TM machines in the different groups transmits the group configuration list of its own group to the TM machine of the other group. When the group configuration list is changed in the other group, the TM machine receives the group configuration list from the TM machine of the other group and distributes the received group configuration list to the ST machine and the CL machine of its own group. As a result, configuration information of all the groups is shared by all the image forming devices forming each group.

FIG. 6 illustrates an example of the group configuration list according to one embodiment of the present invention. A group configuration list 2 includes fields of“group name”, “IP address”, and “type” (ubiquitous function). The CL machine issues an acquisition request of a document list in order to check whether there is a document saved by a user in the ST machine based on the distributed group configuration list. Then, based on the document list acquired from the ST machine, the CL machine outputs an acquisition request of the saved document to the ST machine which saves the document. The CL machine issues the document list acquisition request to the ST machine of its own group in priority to that in the other group.

Note that the image forming system 1 according to this embodiment is configured to be able to select whether the groups cooperate or not; in a case where they do not cooperate, there is no TM machine in the group and there are only the ST machine and the CL machine.

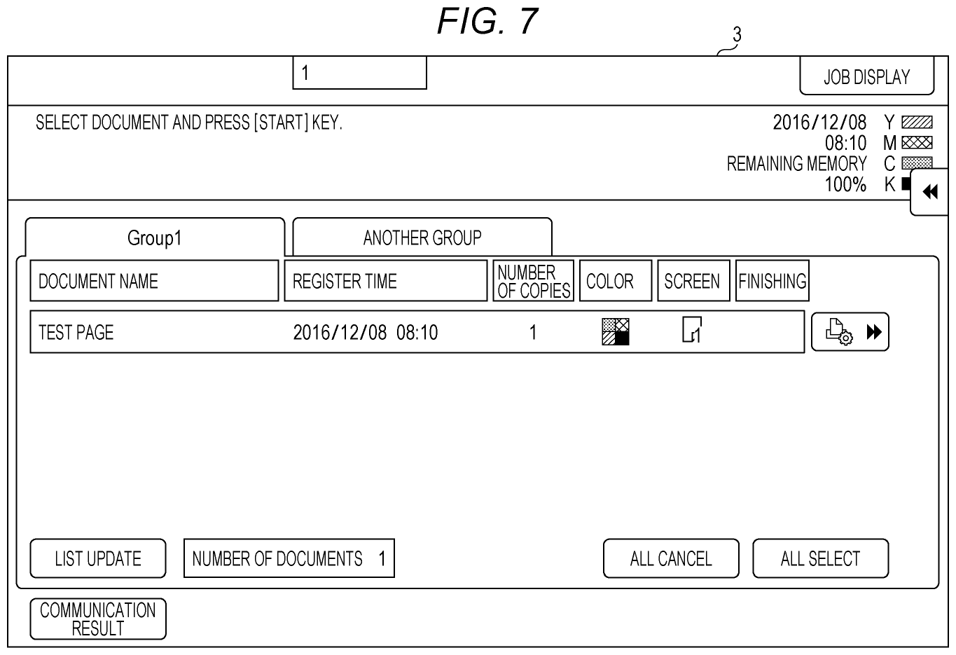

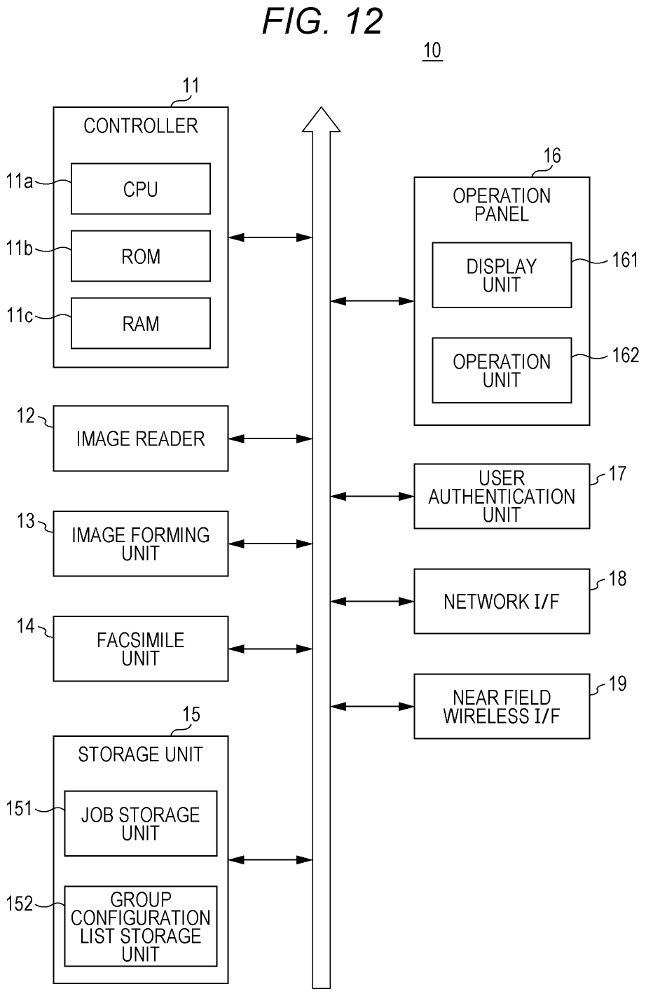

FIG. 7 illustrates an example of a saved document list screen according to one embodiment of the present invention. The example in FIG. 7 is an example in which the user logs in the CL machine of the group 1 and the document list saved in the ST machine of the group 1 is displayed on an operation panel 16 (refer to FIG. 12) of the CL machine. When the user selects the document displayed on a saved document list screen 3 and issues an output instruction, the CL machine acquires the document from the ST machine to output. In a case of displaying a list of the documents saved in the ST machine other than the group 1 on the operation panel 16 of the CL machine of the group 1, by tapping an “other group” tab illustrated in FIG. 7, the CL machine outputs the document list acquisition request to the ST machine in other than the group 1 and acquires the relevant document list to display on the operation panel 16.

[Flow from Document Saving to Output]

Next, a flow from an instruction from a terminal device (an example of an information processing device) to save the document in the ST machine to the output of the document from the CL machine is described.

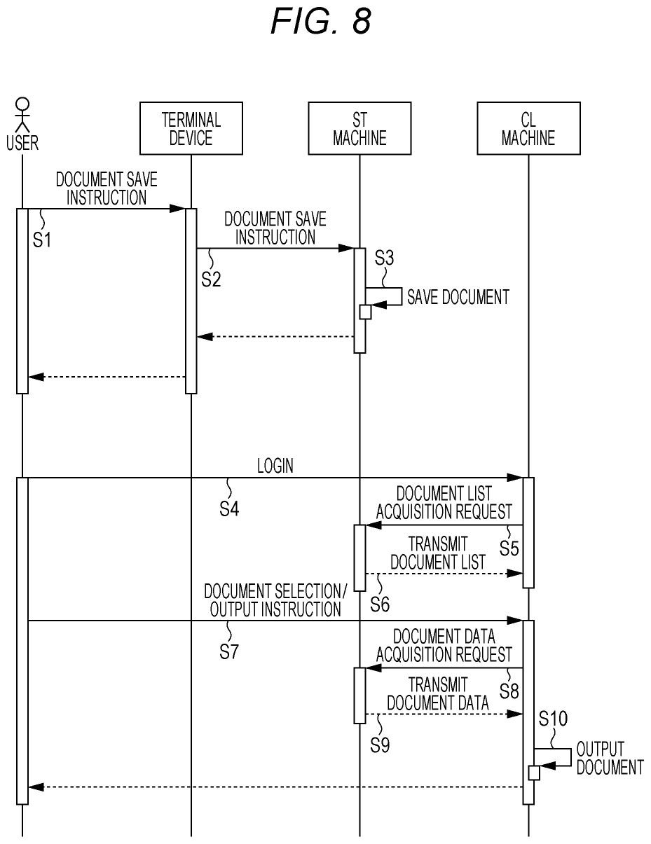

FIG. 8 is a sequence diagram illustrating a general flow from the document saving to output. First, the user operates the terminal device to issue an instruction to save the document (print job generation) (S1). Next, the terminal device issues a document saving instruction to the ST machine (S2). The ST machine saves the document (S3) and transmits a completion notification to the terminal device. The user may confirm that the document is saved in the ST machine by looking at a display screen of the terminal device.

Next, when the user goes to a location where the CL machine is located and logs in the CL machine (S4), the CL machine transmits the document list acquisition request to the ST machine (S5). The ST machine transmits the document list to the CL machine in response to the document list acquisition request (S6). Herein, in a case where there is no target document in the document list acquired from the ST machine of its own group, the CL machine transmits the document list acquisition request to the ST machine of the other group.

Next, when the user selects the document from the document list displayed on the operation panel 16 of the CL machine and issues the output instruction (S7), the CL machine transmits the document data acquisition request to the ST machine (S8). The ST machine transmits the relevant document data to the CL machine in response to the document data acquisition request (S9). The CL machine outputs the document data transmitted from the ST machine (S10), and the user acquires an output product.

Next, the image forming system 1 is described in further detail.

FIG. 9 illustrates a network configuration example of the image forming system 1. A plurality of (in FIG. 9, four) image forming devices 10, a plurality of (in FIG. 9, three) terminal devices 20, and a management server 30 are connected via a communication network N such as a wireless local area network (LAN) so that they can communicate with each other. The image forming device 10 is a multi function peripherals (MFP) having a plurality of functions such as a printer function, a copy function, a facsimile function, and a scanner function for example.

Next, a group creating function in the image forming system 1 is described.

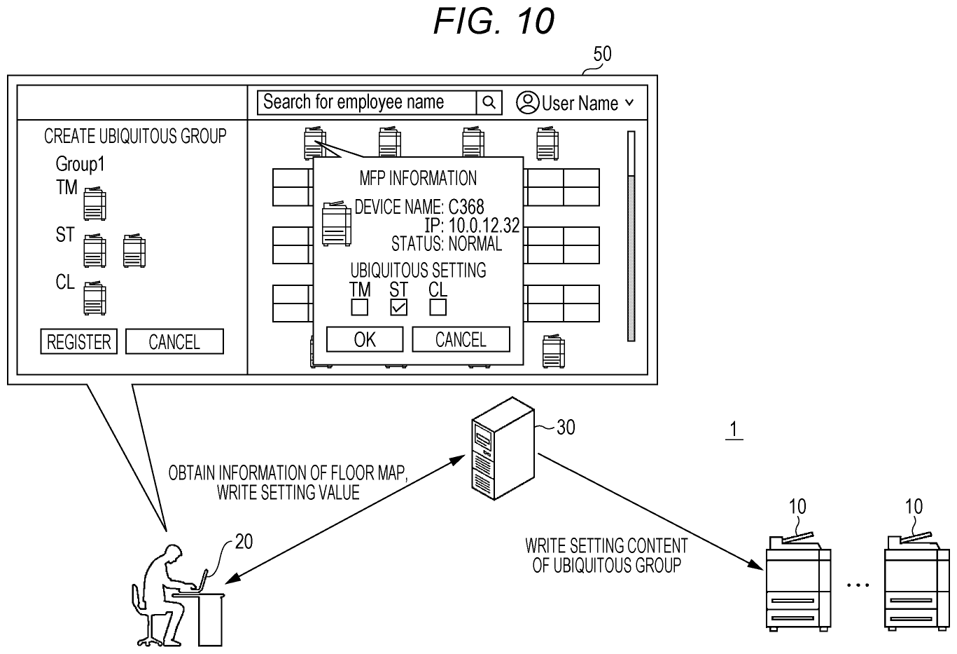

FIG. 10 illustrates the group creating function in the image forming system 1. The image forming system 1 includes the plurality of image forming devices 10, the terminal device 20 used for setting the group, and the management server 30 which manages a floor map. The terminal device 20 acquires information of the floor map from the management server 30, and writes a setting value of the group on a group editing screen 50 by a user input. The management server 30 instructs the image forming device 10 to write a setting content of the group set by the terminal device 20.

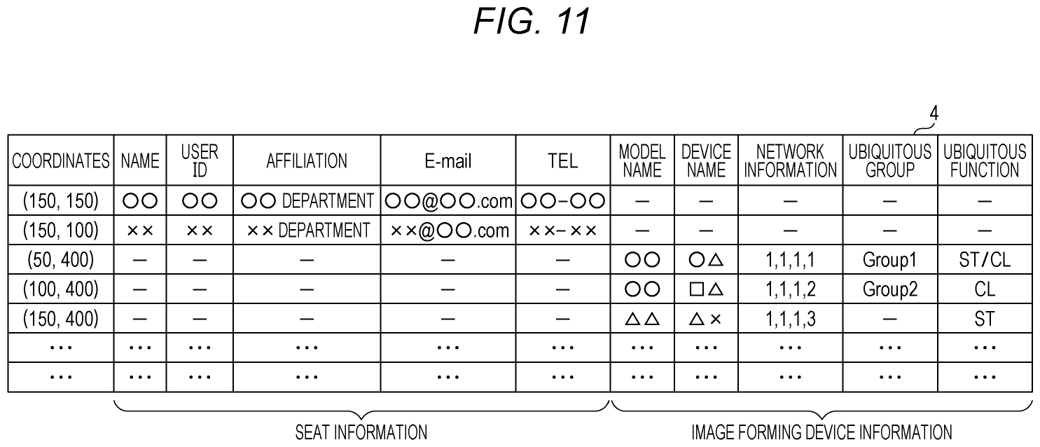

FIG. 11 is a table illustrating a configuration example of floor map data. In a table 4 of this floor map data, “coordinates (X coordinate. Y coordinate)” of a seat and the image forming device 10 to be drawn on the floor map, “name”, “user ID”. “affiliation”. “email address”, and “telephone number” of a person using the seat are recorded in association with each other. Furthermore, in the table 4, “model name” and “device name” of the image forming device 10, “network information” such as an IP address and DNS name, “ubiquitous group” to which this belongs, and “ubiquitous function” set therefor are also recorded in association with each other. The “model name” may be said to be a product name of the image forming device 10. The “device name” is a name of the image forming device 10 which may be arbitrarily set by the user. The “ubiquitous function” is a role (TM/ST/CL) which the image forming device 10 forming a certain group in the image forming system 1 plays in the group.

In a case of data relating to the image forming device 10, “name”, “user ID”. “affiliation”. “email address”, and “telephone number” are recorded as “-”. On the other hand, in a case of data relating to the seat, “model name”, “device name”. “network information”. “ubiquitous group”, and “ubiquitous function” are recorded as “-”. Also, the image forming device 10 which does not belong to any group or the image forming device 10 for which the ubiquitous function is not set yet are recorded with “ubiquitous group” or “ubiquitous function” as “-” The management server 30 stores such table 4 of the floor map data.

As illustrated in FIG. 10, the user activates an application program of the terminal device 20, and the terminal device 20 acquires the information of the floor map which records an installation position and the like of the image forming device 10 from the management server 30 and writes various setting values such as group edition on the group editing screen 50. The management server 30 writes the setting content of the group (for example, the group configuration list 2) in the image forming device 10 (TM machine) forming the group. Then, the setting content is written from the TM machine in the ST machine and the CL machine. Note that not the management server 30 but the image forming device 10 may have a function of issuing an instruction of management of the floor map and writing of the setting content of the group.

[Image Forming Device]

FIG. 12 is a block diagram illustrating a configuration example of the image forming device 10. The image forming device 10 includes a controller 11, an image reader 12, an image forming unit 13, a facsimile unit 14, a storage unit 15, an operation panel 16, a user authentication unit 17, a network interface (network I/F) 18, and a near field wireless interface (near field wireless I/F) 19.

The controller 11 includes a CPU 11a, a ROM 11b, a RAM 11c and the like. The CPU 11a reads various programs stored in the ROM 11b in response to an operation signal input from an operation unit 162 or an instruction signal received by the network interface 18. Then, the CPU 11a comprehensively controls operation of the image forming device 10 by developing the read program in the RAM 11c and executing the same.

The image reader 12 scans to expose an image of an original placed on a document table or an auto document feeder (ADF) not illustrated by an optical system of a scanning exposure device, and reads reflected light by a line image sensor to acquire an image signal.

The image forming unit 13 forms, for example, an image of four colors of cyan (C), magenta (M), yellow (Y), and black (K) according to pixel values of four colors of each pixel of an original image subjected to image processing on paper. As an image forming system of the image forming unit 13, an electrophotographic system, an inkjet system or the like may be applied.

The facsimile unit 14 converts an original into data as a set of black and white dots by an optical reading device, converts the same into an audio signal, and transmits the same to a counterpart facsimile machine via the network interface 18.

The storage unit 15 is a non-volatile storage means formed of a hard disk drive (HDD), a solid state drive (SSD) and the like, and stores various programs, various setting data and the like in a readable/writable manner from the controller 11. The storage unit 15 includes a job storage unit 151 capable of storing various jobs, and a group configuration list storage unit 152 which stores the group configuration list 2 (refer to FIG. 6) transmitted from the management server 30. For example, in a case of acquiring a job transmitted from the terminal device 20 via the network interface 18, the controller 11 allows the job storage unit 151 to store the job. The controller 11 controls operation of its own device based on the ubiquitous function assigned to its own device.

The operation panel 16 includes a display unit 161 which displays various types of information to the user, and an operation unit 162 which receives an operation input from the user. The display unit 161 (an example of an output unit) is formed of a color liquid crystal display or the like, and displays operation screens (various setting screens, various buttons, operation statuses of various functions and the like) according to a display control signal input from the controller 11.

The operation unit 162 includes a touch panel provided on a screen of the display unit 161 and various hard keys arranged around the screen of the display unit 161. In a case where the button displayed on the screen is pressed with a finger or a touch pen, the operation unit 162 detects XY coordinates of a pressed force point with a voltage value, and outputs an operation signal associated with a detected position to the controller 11. Note that the touch panel is not limited to a pressure-sensitive type, and may also be, for example, an electrostatic type or an optical type. In a case where a hard key is pressed, the operation unit 162 outputs an operation signal associated with the pressed key to the controller 11. The user may operate the operation unit 162 to perform settings relating to image formation such as image quality setting, magnification setting, application setting, output setting, and paper setting, a paper conveyance instruction, and a stop operation of the device.

The user authentication unit 17 performs an authentication process for identifying the user by checking authentication data such as an ID and a password input by the user against reference data registered in advance. The authentication data may also be stored in a contactless IC card such as an employee card or a security card. For example, the image forming device 10 includes a reader/writer device (corresponding to the near field wireless interface 19), the reader/writer device reads the authentication data from the contactless IC card, and the user authentication unit 17 authenticates the read authentication data. Note that the reference data may be stored in the storage unit 15, or may be stored in an external server device or the like not illustrated. The user authentication may also be performed by the external server device such as the management server 30, and the user authentication unit 17 may identify the user based on a result thereof.

The network interface 18 is a communication interface which connects the image forming device 10 to the communication network N. The network interface 18 includes a communication IC, a communication connector and the like, and transmits and receives various types of information to and from the other image forming devices 10, the terminal device 20, or the management server 30 connected to the communication network N by using a predetermined communication protocol under control of the controller 11. The network interface 18 may also input/output various types of information via a universal serial bus (USB).

The near field wireless interface 19 is a communication interface which performs near field communication with a communication counterpart, and is mainly used for communication with a mobile terminal or the contactless IC card not illustrated. The near field wireless interface 19 complies with, for example, Bluetooth (registered trademark), Near Field Communication (NFC), and Infrared Data Association (IrDA) standards.

The image forming device 10 may further include a microphone and a speaker not illustrated.

[Terminal Device]

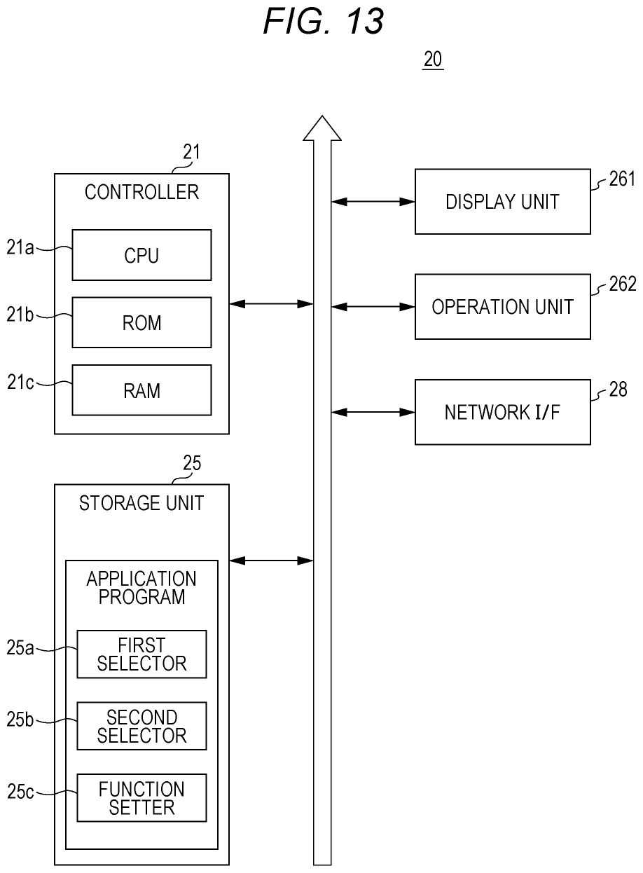

FIG. 13 is a block diagram illustrating a configuration example of the terminal device 20. The terminal device 20 selects the image forming device 10 allowed to belong to the group from the floor map in which the installation positions and device information of the plurality of image forming devices 10 are registered, and associates the information of the selected image forming device 10 with the group to register in the TM machine.

A general-purpose computer such as a personal computer may be used as the terminal device 20. The terminal device 20 includes a controller 21, a storage unit 25, a display unit 261, an operation unit 262, and a network interface (network I/F) 28. The terminal device 20 may further include a microphone and a speaker not illustrated. Basic specifications of the controller 21, the storage unit 25, and the network interface 28 may be equivalent to those of the controller 11, the storage unit 15, and the network interface 18 included in the image forming device 10.

The storage unit 25 stores an application program (hereinafter abbreviated as “application”). The application is a program which realizes group construction/editing, ubiquitous function setting, document output (printer driver) and the like based on user instructions input to the operation unit 262.

In FIG. 13, the application program includes programs which serve as a first selector 25a, a second selector 25b, and a function setter 25c. The first selector 25a selects information of the image forming device 10 drawn on the floor map based on the user instruction. The second selector 25b selects one group out of the groups registered in advance. As a result, the image forming device 10 selected by the first selector 25a is additionally registered in the group selected by the second selector 25b. Furthermore, the function setter 25c selects and sets the ubiquitous function to be assigned to the image forming device 10 selected from the floor map.

Applications for group construction/editing and ubiquitous function setting may be stored in the storage unit 25 in advance, or may be downloaded from the management server 30 to be installed in the terminal device 20. Alternatively, such application may operate on the management server 30.

The display unit 261 displays various types of information to the user. The display unit 261 is formed of a color liquid crystal display or the like. The operation unit 262 accepts an operation input by the user. As the operation unit 262, for example, an input device such as a keyboard and a mouse is used. The operation unit 262 outputs an operation signal associated with the pressed key to the controller 21.

[Management Server]

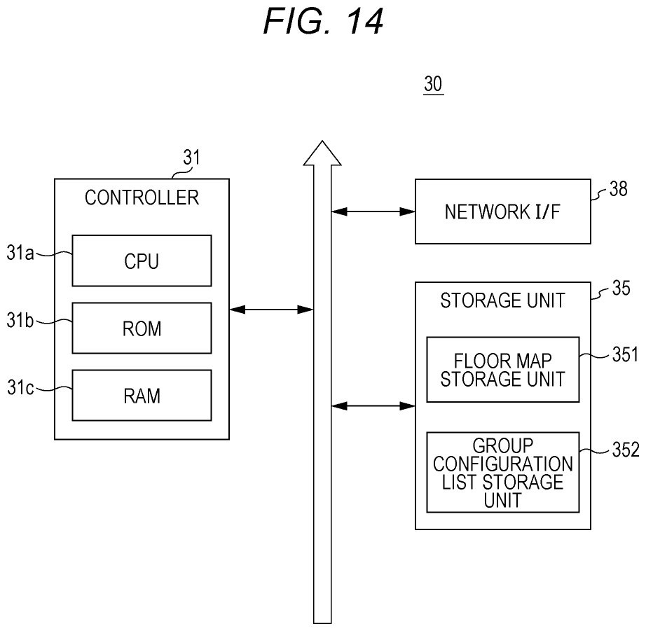

FIG. 14 is a block diagram illustrating a configuration example of the management server 30. The management server 30 includes a controller 31, a storage unit 35, and a network interface (network I/F) 38. Basic specifications of the controller 31, the storage unit 35, and the network interface 38 are equivalent to those of the controller 21, the storage unit 25, and the network interface 28 included in the terminal device 20.

The storage unit 35 includes a floor map storage unit 351 and a group configuration list storage unit 352. The floor map storage unit 351 stores the table 4 of the floor map data (refer to FIG. 11) created by the user. The group configuration list storage unit 352 stores the group configuration list 2 created by the user. The controller 31 transmits the table 4 of the floor map data to the terminal device 20 and transmits the group configuration list 2 to the terminal device 20 or the image forming device 10.

[Method of Creating Group]

Next, a method of creating the group from a plurality of image forming devices 10 according to this embodiment is described.

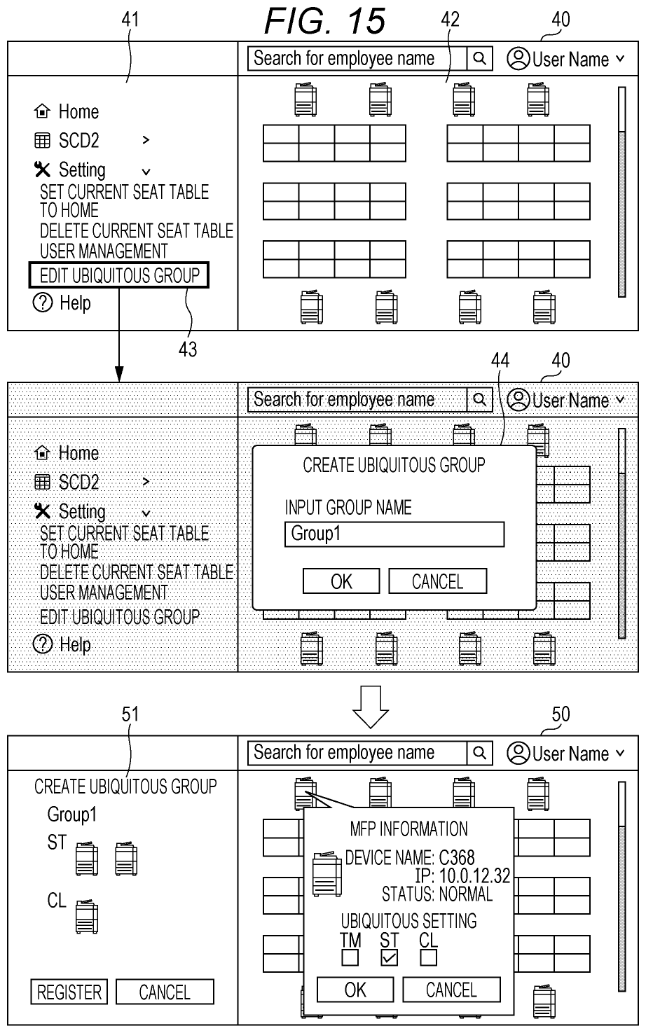

FIG. 15 illustrates an example of a group creating method in the image forming system 1. The user operates the terminal device 20 to access the management server 30 to acquire the floor map data, and allows the display unit 161 to display a floor map management screen 40 (upper part in FIG. 15). On the floor map management screen 40, a menu display area 41 is arranged on a left side, and a floor map display area 42 is arranged on a right side.

In the floor map display area 42, the floor map illustrating arrangement positions of the image forming devices 10 on a seat chart of employees prepared for each department or floor is displayed. The menu display area 41 is provided with a ubiquitous group editing menu 43 for constructing and editing the ubiquitous group.

When the user clicks the ubiquitous group editing menu 43 in the menu display area 41, a ubiquitous group creating window 44 is popped up on the floor map management screen 40 (middle part in FIG. 15). When a group name is input and an OK button is pressed in this ubiquitous group creating window 44, a new group is created. Thereafter, the group editing screen 50 for constructing and editing the group is displayed (lower part in FIG. 15).

On the group editing screen 50, the user sets the image forming device 10 to be added to the group and the role of the ubiquitous function (TM/ST/CL) assigned thereto as a detail of the group. The user selects the image forming device 10 to be added to the group from the floor map, and sets the role of the ubiquitous function (TM/ST/CL). In the group display area 51, the image forming device 10 already set is drawn. For example, when the drawn image forming device 10 is clicked, it is displayed such that it is understood which image forming device 10 on the floor map this is. Then, the setting registration is completed by pressing a registration button.

In FIG. 15, the role of the ubiquitous function is set using a check box, but the present invention is not limited to this example. Note that, in a case where this does not cooperate with the ST machine and CL machine of the other group, the check box of the TM machine may be deleted so that selection and setting cannot be performed.

In this manner, the user selects the menu for constructing the group from the displayed floor map, sets the group name, and selects the image forming device 10 to be added to the set group from the floor map. Then, as illustrated in FIG. 10, the management server 30 which manages the floor map stores the setting content of the group set by the user as the group configuration list, and transmits an instruction to write the group configuration list to the image forming device 10. The image forming device 10 receives the instruction and writes the group configuration list in a storage area of the storage unit 15 (group configuration list storage unit 152).

[Procedure of Group Setting Process]

Next, a procedure example of a group setting process in the image forming system 1 is described.

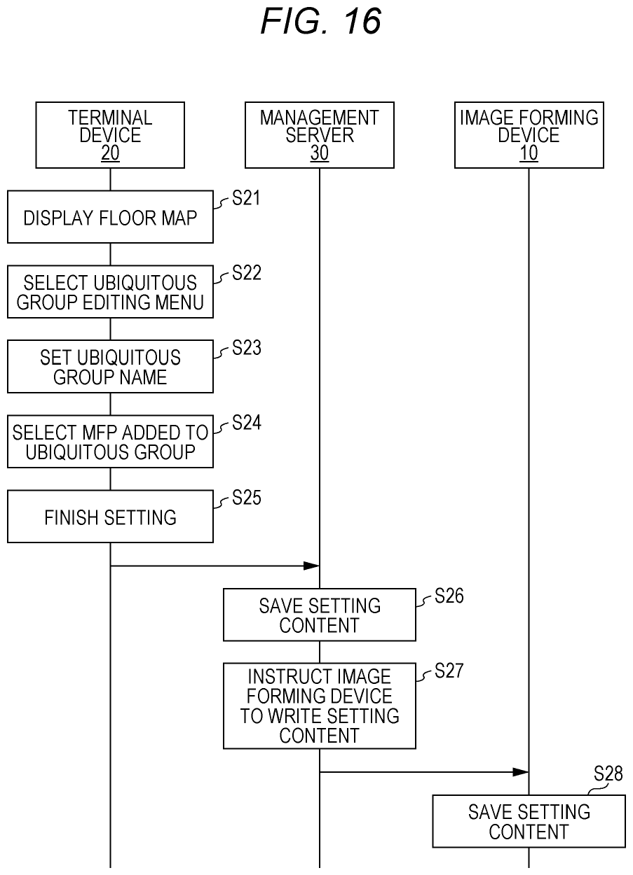

FIG. 16 is a sequence diagram illustrating the procedure example of the group setting process in the image forming system 1.

First, the controller 11 of the terminal device 20 acquires the floor map from the management server 30 and displays the floor map on the display unit 161 (S21). Next, the controller 11 selects the menu for constructing the ubiquitous group (ubiquitous group editing menu 43) according to the user instruction (S22). Next, the controller 11 sets the ubiquitous group name according to the user instruction (S23). Furthermore, the controller 11 selects the image forming device 10 (indicated as MFP in FIG. 16) to be added to the ubiquitous group (S24), finishes the setting (S25), and transmits the setting content to the management server 30.

Next, the management server 30 receives a setting ending notification and the setting content transmitted from the terminal device 20, and stores them in the storage unit 25 (S26). Next, the management server 30 instructs the image forming device 10 to write the setting content (group configuration list) (S27).

Then, the image forming device 10 receives the instruction to write the setting content from the management server 30, and saves the setting content in the storage unit 15 (S28). After the process at step S28, the setting and registration of one group is completed.

[Response to Document Acquisition Request from Other Group]

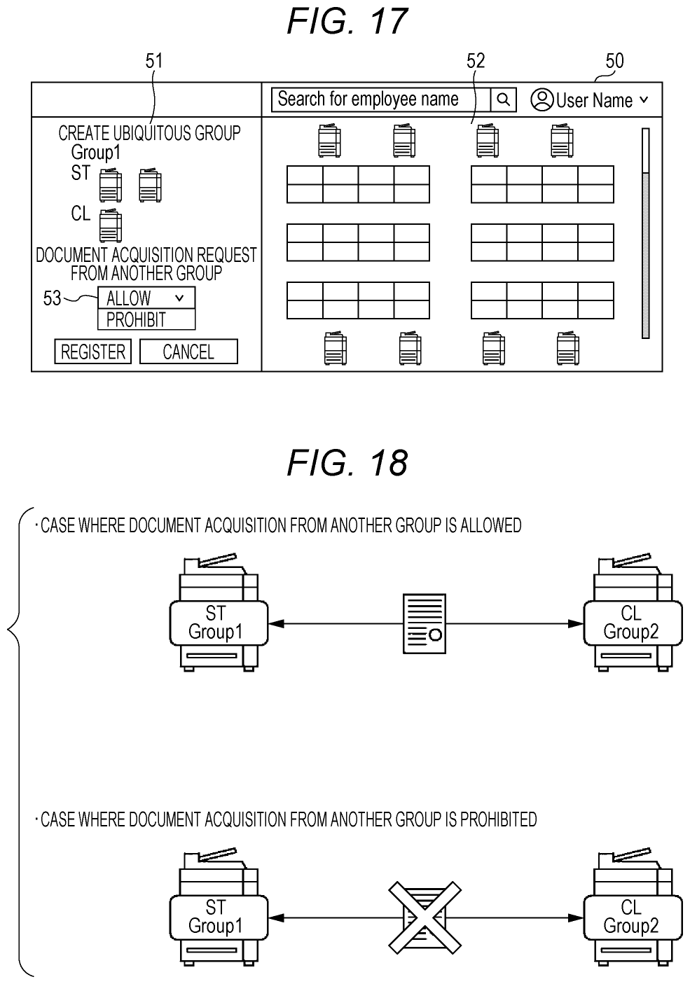

FIG. 17 illustrates a screen for setting a response in a case where there is the document acquisition request from the image forming device 10 of the other group. On the group editing screen 50 illustrated in FIG. 17, a group display area 51 is arranged on a left side, and a floor map display area 52 is arranged on a right side. In the floor map display area 52, eight image forming devices 10 are displayed. However, in the drawing, a reference numeral 10 of the image forming device is omitted.

In the group display area 51, an option 53 capable of setting whether to prohibit or allow acquisition (provision) of the document list in its own group and the document output in response to the document acquisition request from the CL machine of the other group is displayed. The user may set the response to the document acquisition request from the CL machine of the other group by selecting either “allow” or “prohibit” listed in the option 53. Then, the setting registration is completed by pressing a registration button.

FIG. 18 illustrates an effect for each setting content in a case where there is the document acquisition request from the image forming device 10 of the other group. In a case of allowing the document acquisition from the other group, the document list and document data are exchanged between different groups. For example, FIG. 18 illustrates a state in which target document data is shared by the ST machine of the group 1 and the CL machine of the group 2 in response to the document acquisition request from the CL machine of the group 2. On the other hand, in a case where the document acquisition from the other group is prohibited, the document list and document data are not exchanged between the different groups.

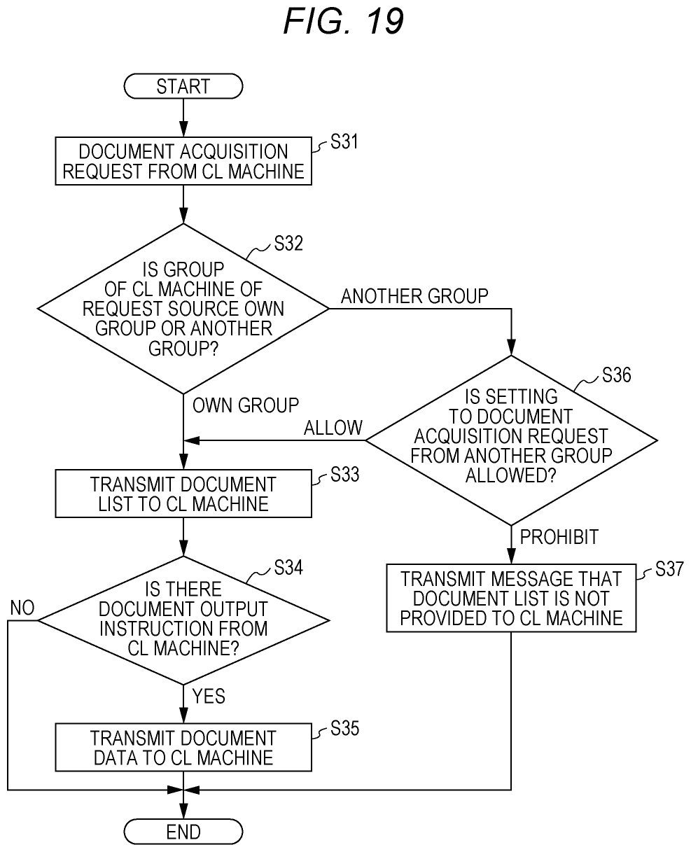

FIG. 19 is a flowchart illustrating a procedure example of a process performed by the ST machine in a case where there is the document acquisition request from the image forming device 10 of the other group. Each processing step in this flowchart is executed by the controller 11 of the ST machine.

First, the ST machine accepts the document acquisition request from the CL machine (S31). Next, the ST machine determines the group to which the CL machine of a request source belongs with reference to the group configuration list 2 (S32). In a case where the request source CL machine belongs to its own group (own group at S32), the ST machine transmits the document list to the CL machine (S33).

Next, the ST machine determines whether there is the document output instruction from the CL machine of the request source (S34), and in a case where there is the document output instruction from the CL machine (Yes at S34), this transmits the document data to the CL machine (S35). In a case of No determination at step S34, or after the process at step S35 ends, the procedure of this flowchart is ended.

In a case where the CL machine of the request source belongs to the other group at step S32 (other group at S32), the ST machine determines the setting content for the document acquisition request from the other group (S36). Herein, in a case where it is set to allow for the document acquisition request from the other group (allow at S36), the ST machine shifts to a process at step S33. On the other hand, in a case where it is set to prohibit for the document acquisition request from the other group (prohibit at S36), the ST machine transmits a message indicating not to provide the document list to the CL machine of the request source (S37), and the procedure in this flowchart is ended.

In this manner, in a case where it is set to prohibit for the document acquisition request from the image forming device of the other group, it is possible to improve security of the group to which the ST machine which receives the request belongs, and eventually the image forming system. Since the document output of the other group is not performed, it is possible to prevent an increase in processing load of the group to which the ST machine belongs.

[Response to Document Acquisition Request from Image Forming Device Group to which this Belongs is not Yet Set]

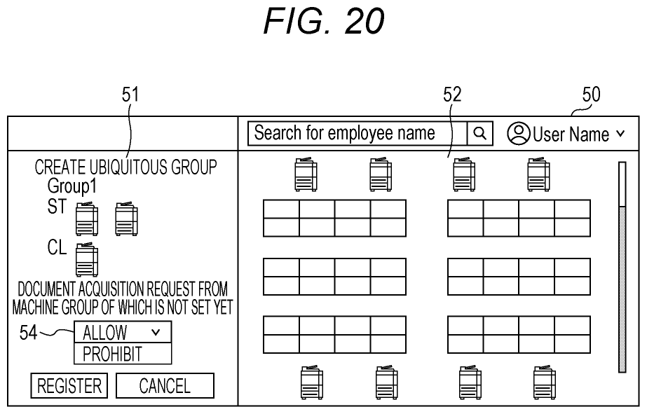

FIG. 20 illustrates a screen for setting a response in a case where there is the document acquisition request from the image forming device the group to which this belongs is not yet set (hereinafter referred to as “group unset machine”).

In the group display area 51 in FIG. 20, an option 54 capable of setting whether to prohibit or allow the acquisition (provision) of the document list and the document output in its own group in response to the document acquisition request from the machine of which group is not yet set (CL machine) is displayed. By selecting either “allow” or “prohibit” listed in the option 54, the user may set a response to the document acquisition request from the CL machine the group to which this belongs is not yet set. That is, it is possible to select whether to allow or prohibit the document acquisition request from the CL machine for which the CL function is set but the group setting is not yet set. In a case where it is set to allow, the ST machine transmits the document list and the document data to the CL machine of the request source in response to the document acquisition request from the CL machine.

In this manner, in a case where it is set to prohibit for the document acquisition request from the image forming device the group to which this belongs is not yet set, the request of the image forming device of which identity is not clear is denied, so that it is possible to improve security of the group to which the ST machine which receives the request belongs and eventually the image forming system 1. Further, since the document output is not performed for the image forming device the identity of which is unclear, it is possible to prevent an increase in the processing load of the group to which the ST machine belongs.

[Method of Adding Image Forming Device to Group]

Next, a method of adding the image forming device 10 to the group is described.

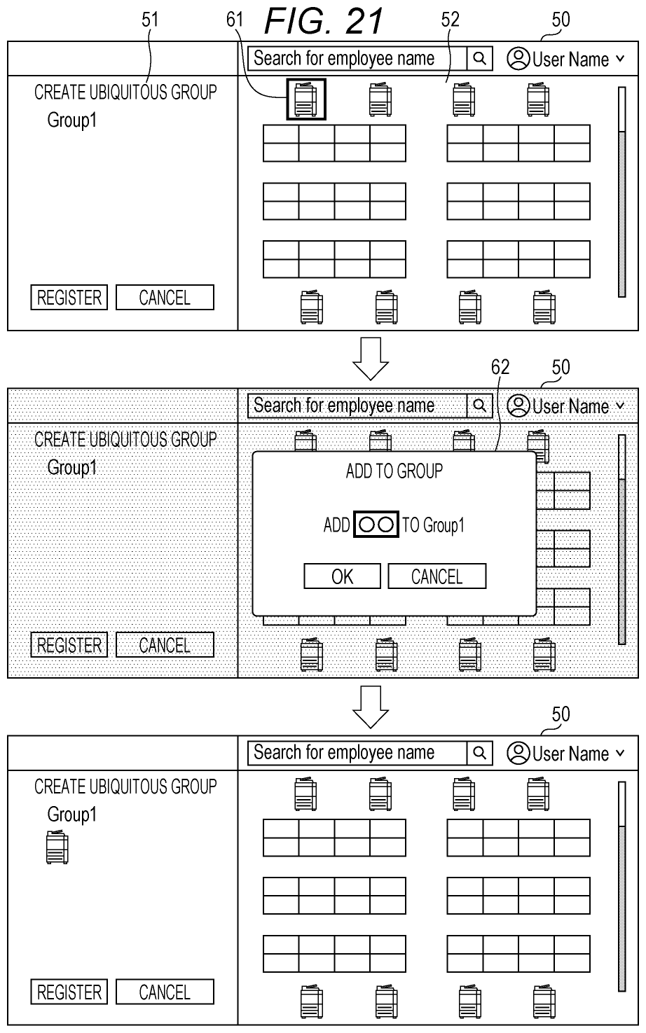

FIG. 21 illustrates a first method of adding the image forming device 10 to the group in the image forming system 1. First, the user operates the terminal device 20 to access the management server 30, acquires the floor map data, and allows the display unit 261 to display the group editing screen 50 (upper part in FIG. 21). Then, information (icon) indicating one image forming device 10 (frame 61) is individually selected from the image forming devices 10 displayed in the floor map display area 52.

When tire image forming device 10 is selected, a group adding window 62 is popped up on the group editing screen 50 (middle part in FIG. 21), so that the user selects whether to add the selected image forming device 10 to the group. In the group adding window 62, for example, a message such as “Add ◯◯ to Group 1” is displayed. Then, when an OK button in the group adding window 62 is pressed, the image forming device 10 added to the group 1 is drawn in the group display area 51 (lower part in FIG. 21). Then, the setting registration is completed by pressing a registration button.

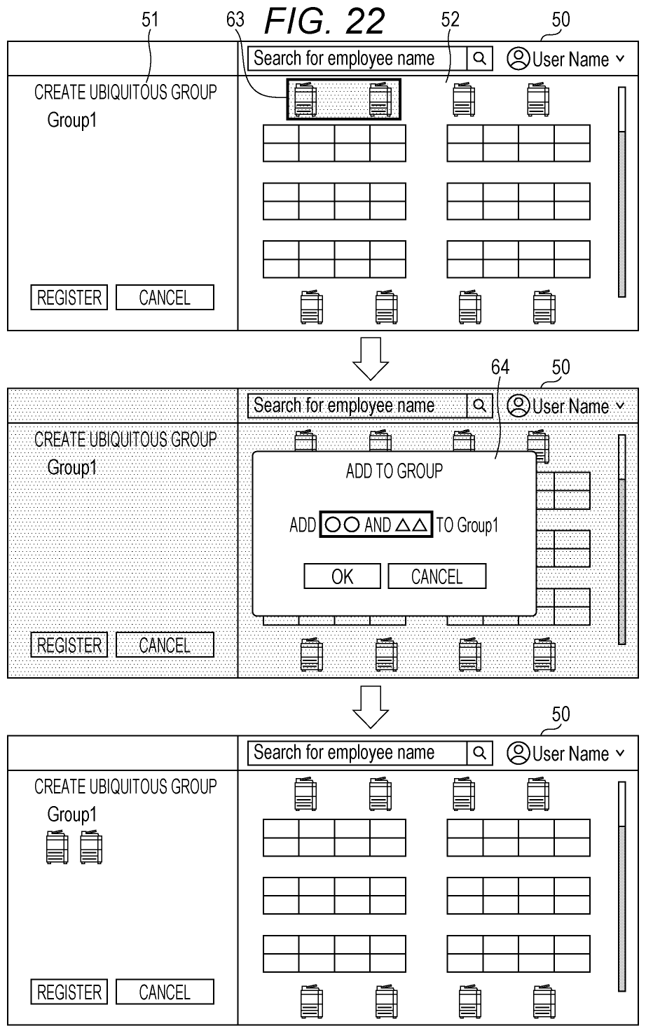

FIG. 22 illustrates a second method of adding the image forming device 10 to the group in the image forming system 1. An area 63 is specified in the floor map display area 52 (upper part in FIG. 22), and the image forming devices 10 present within a range of the specified area 63 are collectively selected to be added to the group. When the area 63 is specified, a group adding window 64 is popped up on the group editing screen 50 (middle part in FIG. 22), so that the user selects whether to add the specified image forming device 10 to the group. In tire group adding window 64, for example, a message such as “Add ◯◯ and ΔΔ to Group1” is displayed. Then, when an OK button in the group adding window 64 is pressed, the image forming devices 10 (two in the drawing) added to the group 1 are drawn in the group display area 51 (lower part in FIG. 22).

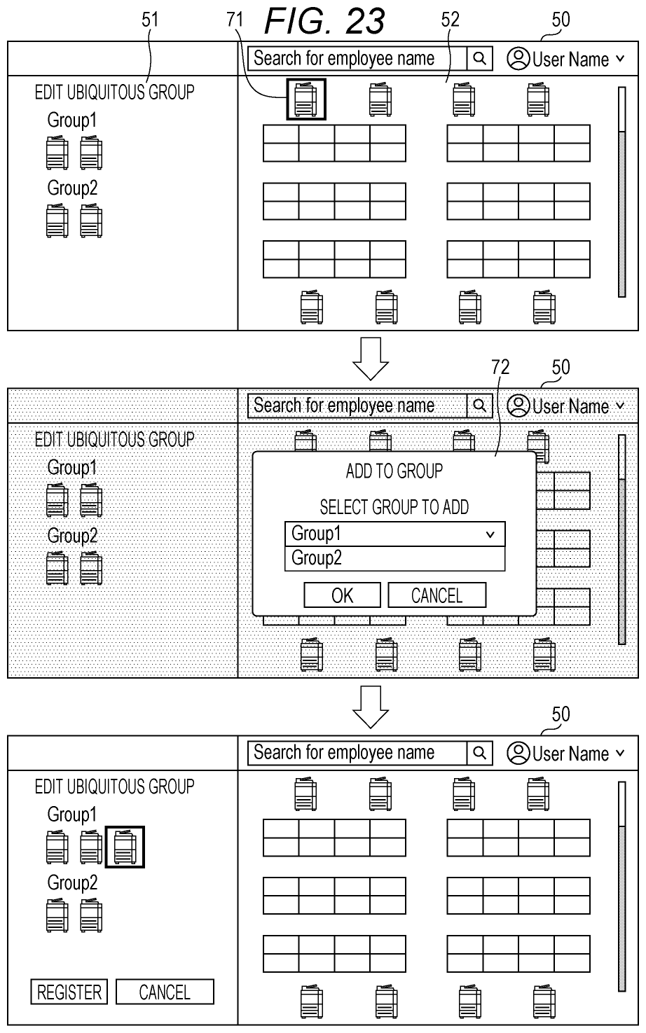

FIG. 23 illustrates a third method of adding the image forming device 10 to the group in the image forming system 1. The third method is to select the image forming device 10 drawn on the floor map display area 52 which does not yet belong to any group in a state in which the group is already constructed, thereby selecting the ubiquitous group to which the image forming device 10 is added.

When one image forming device 10 (frame 71) is selected from the image forming devices 10 displayed in the floor map display area 52 (upper part in FIG. 23), a group adding window 72 is popped up on the group editing screen 50 (middle part in FIG. 23). The user selects the group from the group list on the group adding window 72, thereby adding the selected image forming device 10 to the selected group. Then, when an OK button in the group adding window 72 is pressed, the image forming device 10 added to the selected group (group 1 in the drawing) is drawn in the group display area 51 (in frame in lower part in FIG. 23).

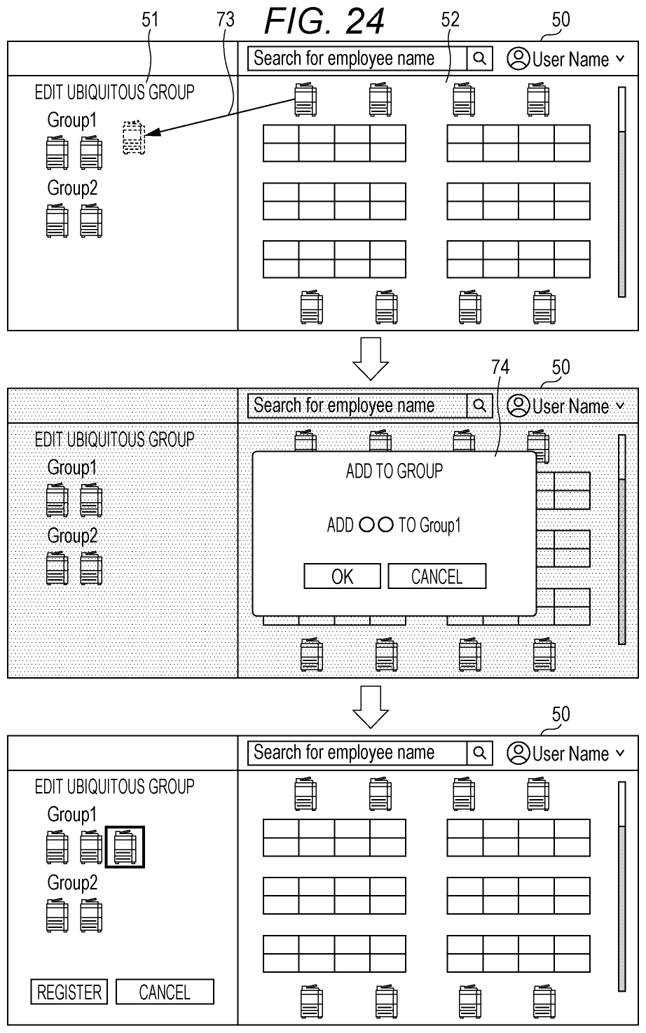

FIG. 24 illustrates a fourth method of adding the image forming device 10 to the group in the image forming system 1. The fourth method is to select the image forming device 10 which does not belong to any group yet drawn on the floor map display area 52 and performs drug-and-drop of the same to the group display list in a state in which the group is already constructed, thereby adding to register the selected image forming device 10 in the group in which this is dropped.

From the image forming devices 10 drawn in the floor map display area 52, the image forming device 10 which does not belong to any group yet is selected, and drag-and-drop of the same to the group display list in the group display area 51 is performed (arrow 73 in upper part in FIG. 24). Immediately thereafter, a group adding window 74 is popped up on the group editing screen 50 (middle part in FIG. 24), so that the user selects whether to add the selected image forming device 10 to the group. In the group adding window 74, for example, a message such as “Add ◯◯ to Group 1” is displayed. Then, when an OK button in the group adding window 74 is pressed, the image forming device 10 added to the selected group (group 1 in the drawing) is displayed in the group display area 51 (in frame in lower part in FIG. 24).

[Method of Checking Ubiquitous Function Assigned to Image Forming Device]

Next, a method of checking the ubiquitous function assigned to the image forming device 10 is described.

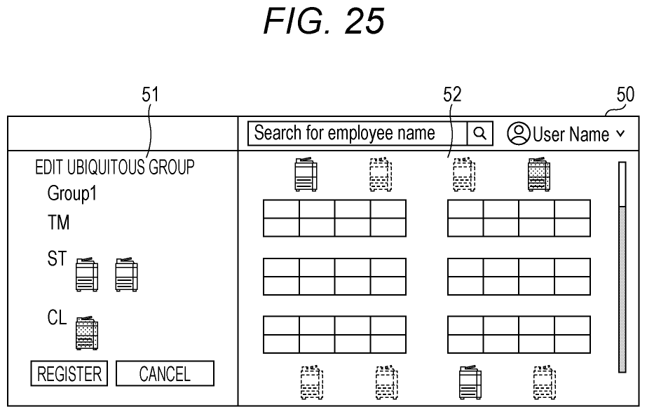

FIG. 25 illustrates a first screen example for checking the ubiquitous function assigned to the image forming device 10 in the image forming system 1. In the group display area 51 of the group editing screen 50, three image forming devices 10 forming the group 1 are drawn. Breakdown is as follows: two ST machines and one CL machine. In FIG. 25, the CL machine in the group display area 51 is drawn with high density (dot pattern display in the drawing). Then, in the floor map display area 52, the image forming device 10 (rightmost one of upper four devices in FIG. 25) corresponding to the CL machine in the group display area 51 is drawn with high density. Drawing with high density is an example of highlighting, and color coding or another method may also be used as long as it is possible to distinguish for each ubiquitous function. Note that, out of eight image forming devices 10 in the floor map display area 52, the image forming device 10 which does not form the group 1 is indicated by a broken line.

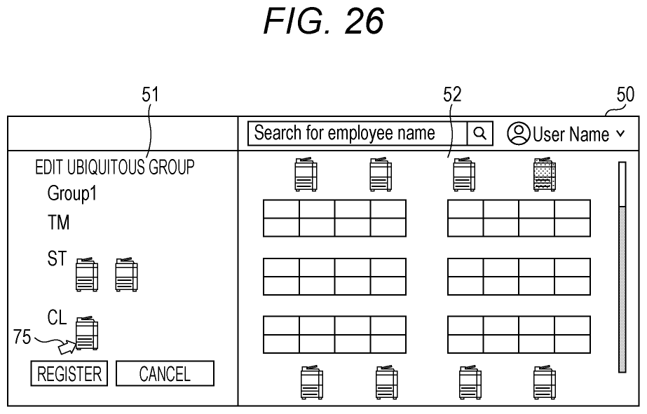

FIG. 26 illustrates a second screen example for checking the ubiquitous function assigned to the image forming device 10 in the image forming system 1. Breakdown of the ubiquitous functions of the three image forming devices 10 forming the group 1 in FIG. 26 is the same as that in FIG. 25. In FIG. 26, the three image forming devices 10 drawn in the group display area 51 are drawn with the same density. When a pointer 75 is moved to the CL machine (or moved to click the same), the image forming device 10 corresponding to the CL machine is drawn with high density in the floor map display area 52.

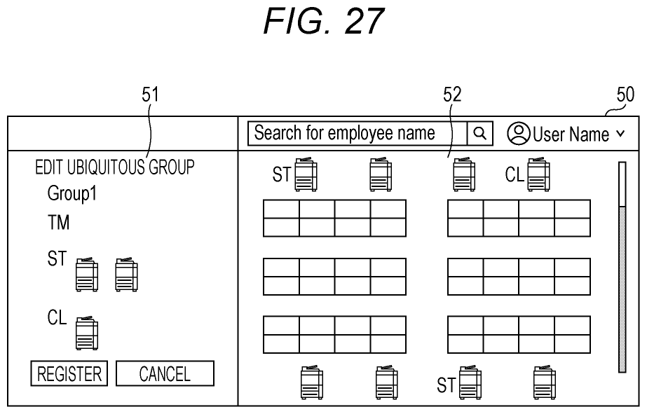

FIG. 27 illustrates a third screen example for checking the ubiquitous function assigned to the image forming device 10 in the image forming system 1. Breakdown of the ubiquitous functions of the three image forming devices 10 forming the group 1 in FIG. 27 is the same as that in FIG. 25. In the third screen example, the role of the ubiquitous function (for example, ST/CL) of the three image forming devices 10 forming the group 1 of the group display area 51 is described in each corresponding image forming device 10 in the floor map display area 52.

[Method of Checking Image Forming Devices Forming Group]

Next, a method of checking the image forming devices 10 forming the group is described.

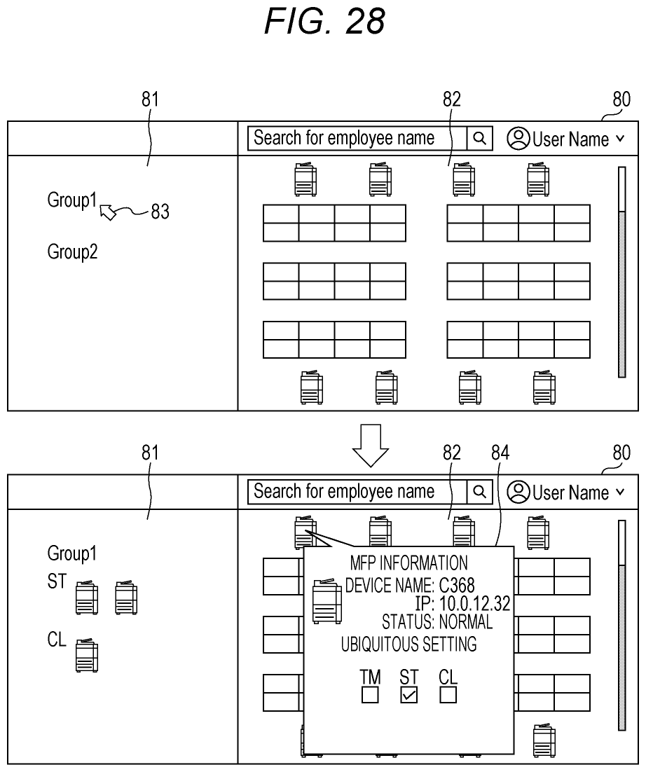

FIG. 28 illustrates a first screen example for checking the image forming devices 10 forming the group in the image forming system 1. In FIG. 28, “group 1” and “group 2” are displayed in a group display area 81 (upper side in FIG. 28). Although the user may know that the groups 1 and 2 are constructed by this display, the user does not know about the image forming devices 10 forming each group. Therefore, the user moves a pointer 83 to select the group which the user wants to check and check the group configuration.

When the group 1 is selected by the pointer 83 in the group display area 81, the image forming devices 10 forming the group 1 are displayed for each ubiquitous function (two ST machines and one CL machine) (lower side in FIG. 28). When the user clicks on the image forming device 10 in the group display area 81, an image forming device information window 84 is popped up as a balloon of information (icon) indicating the image forming device 10 on the floor map corresponding to the selected image forming device 10. The image forming device information window 84 displays detailed information including, for example, the device name of the image forming device 10, network information (IP address), status indicating normal/abnormal, and ubiquitous function setting.

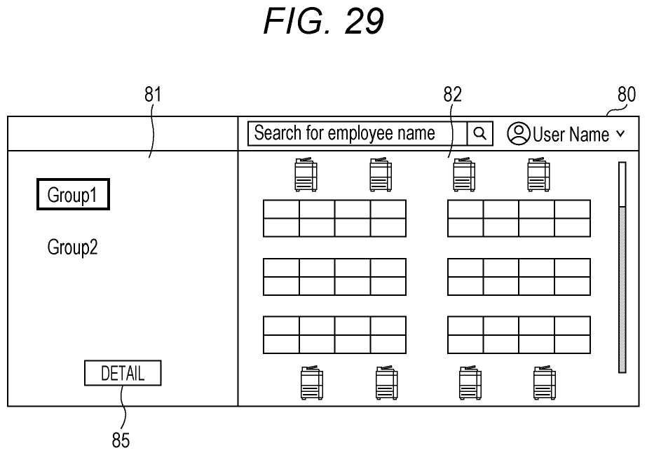

FIG. 29 illustrates a second screen example for checking the image forming devices 10 forming a group in the image forming system 1. In FIG. 29, “group 1” and “group 2” are displayed in the group display area 81 (FIG. 29). In FIG. 29, when the user selects the group 1 and presses a detail button 85, the image forming devices 10 forming the group 1 are displayed as illustrated in the lower side of FIG. 28. Then, by selecting the image forming devices 10 forming the group 1, the image forming device information window 84 is displayed.

[Method of Setting Ubiquitous Function to be Assigned to Image Forming Device]

Next, a method of selecting and setting the ubiquitous function assigned to the image forming device 10 is described.

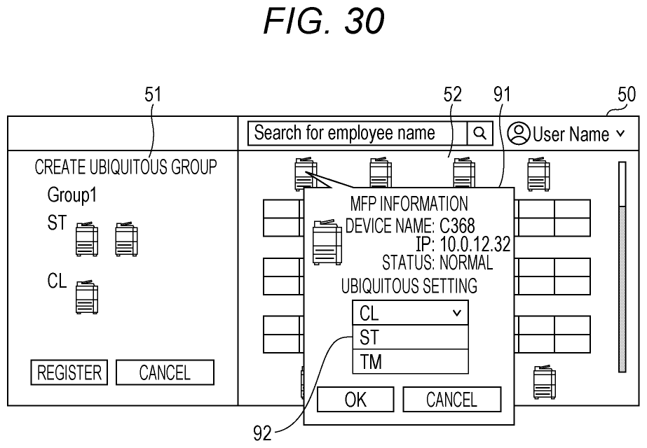

FIG. 30 illustrates a first screen example for setting the ubiquitous function assigned to the image forming device 10 in the image forming system 1. As illustrated in FIG. 30, the function setter 25c of the terminal device 20 selects the image forming device 10 drawn in the floor map display area 52, and pops up an image forming device information window 91. The image forming device information window 91 displays a ubiquitous function list 92 in a list format. The user selects and sets the TM function, ST function, and CL function from the ubiquitous function list 92. After selecting the ubiquitous function, pressing the OK button completes the assignment of the ubiquitous function to the image forming device 10.

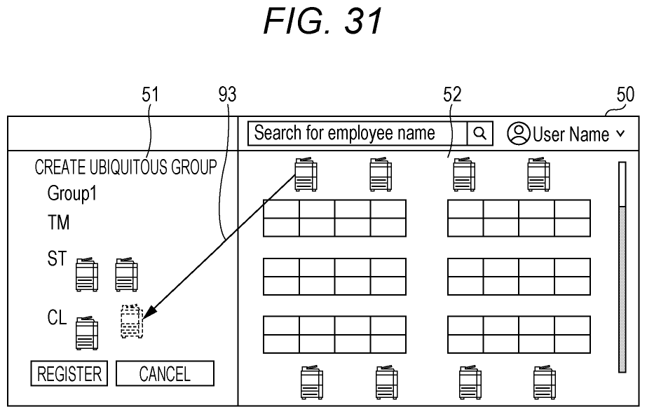

FIG. 31 illustrates a second screen example for setting the ubiquitous function assigned to the image forming device 10 in the image forming system 1. As illustrated in FIG. 31, in the group display area 51 of the group editing screen 50, the already registered group and a list of the image forming devices 10 registered in the group and for which function setting (TM/ST/CL) is completed (corresponding to the function list) are drawn. Herein, the image forming device 10 drawn on the floor map display area 52 for which the function setting is not completed yet is selected, and drag-and-drop of the same to an area (corresponding to a function) indicating the function list, that is, any of the TM machine, ST machine, and CL machine (arrow 93), thereby assigning the function to the image forming device 10.

With these operations, the user may select the ubiquitous function with a simple operation. Especially, according to the method illustrated in FIG. 31, the selection of the image forming device 10 and the assignment of the ubiquitous function may be performed simultaneously by a series of operations, so that working efficiency is better than that in the method illustrated in FIG. 30.

[Recommendations and Inquiry for Ubiquitous Function]

In addition to the saving of the document transmitted from the terminal device 20 and transmission of the document list and document data in response to the document acquisition request from the CL machine, the ST machine may use the CL function, and may be used with the facsimile function, copy function, and scan function in addition to a function of server-less ubiquitous printing. Therefore, the ST machine is considered to have a higher load than the CL machine alone. Therefore, the function setter 25c of the terminal device 20 is configured to present an appropriate function based on specifications (for example, performance and function) of the selected image forming device 10 (installed memory or CPU). For example, the function setter 25c of the terminal device 20 proposes that a high-spec image forming device 10 has the ST function and a low-spec image forming device 10 has the CL function.

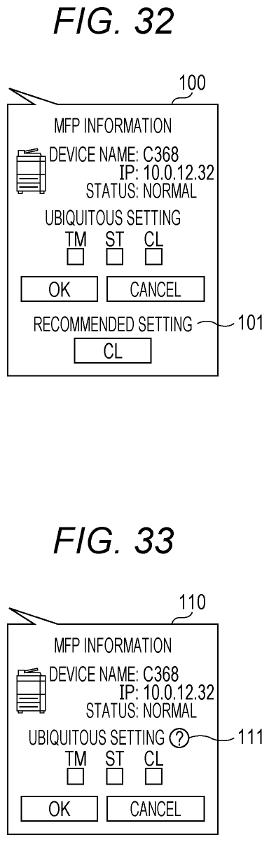

FIG. 32 illustrates an example in which the ubiquitous function to be assigned to the image forming device 10 is recommended in the image forming system 1. In the example in FIG. 32, a recommended setting 101 of the ubiquitous function for the selected image forming device 10 is displayed in a popped up image forming device information window 100. The user may set the ubiquitous function with reference to the recommended setting 101.

With such configuration, an appropriate ubiquitous function may be set according to the load of each image forming device 10. Accordingly, it is possible to prevent the load from being concentrated on the specific image forming device 10 and to distribute the load among the plurality of image forming devices 10 forming the image forming system 1.

FIG. 33 illustrates an example in which an inquiry is made about the ubiquitous function to be assigned to the image forming device 10 in the image forming system 1. In the example in FIG. 33, an inquiry button 111 which allows the user to make an inquiry about appropriate setting of ubiquitous functions for the selected image forming device 10 is displayed in the popped up image forming device information window 110. For example, when the user presses the inquiry button 111, a recommended setting of the ubiquitous functions as illustrated in FIG. 32 is displayed.

[Method of Checking Group to which Image Forming Device Belongs]

Next, a method of simply checking the group to which the image forming device belongs is described.

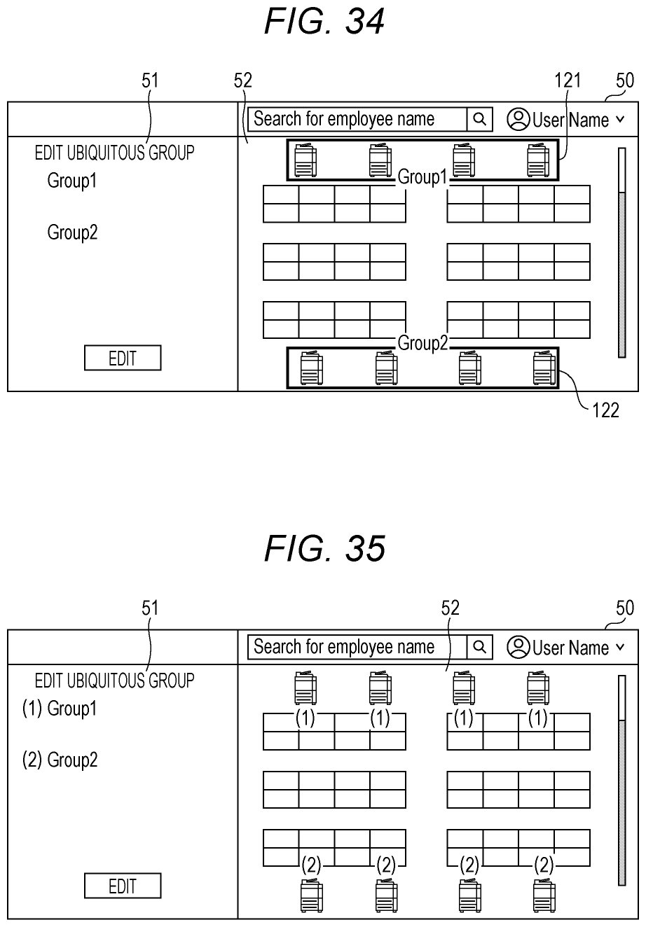

FIG. 34 illustrates a first screen example for checking the group to which the image forming device 10 displayed on the floor map belongs in the image forming system 1. The example in FIG. 34 displays the group to which the image forming device 10 drawn in the floor map display area 52 belongs. In FIG. 34, it is clearly illustrated that upper four image forming devices 10 belong to the group “Group1” by using a frame 121, and the lower four image forming devices 10 belong to the ubiquitous group “Group2” using the frame 122.

FIG. 35 illustrates a second screen example for checking the group to which the image forming device displayed on the floor map belongs in the image forming system according to one embodiment of the present invention. In FIG. 35. “(1)” indicating “Group1” is displayed in the information (icon) indicating the upper four image forming devices 10, and “(2)” indicating “Group2” is displayed in the image indicating the lower four image forming devices 10.

With these display forms, the user may confirm at a glance the group to which each of the plurality of image forming devices 10 on the floor map belongs.

[Response when Image Forming Device Cannot be Added to Group]

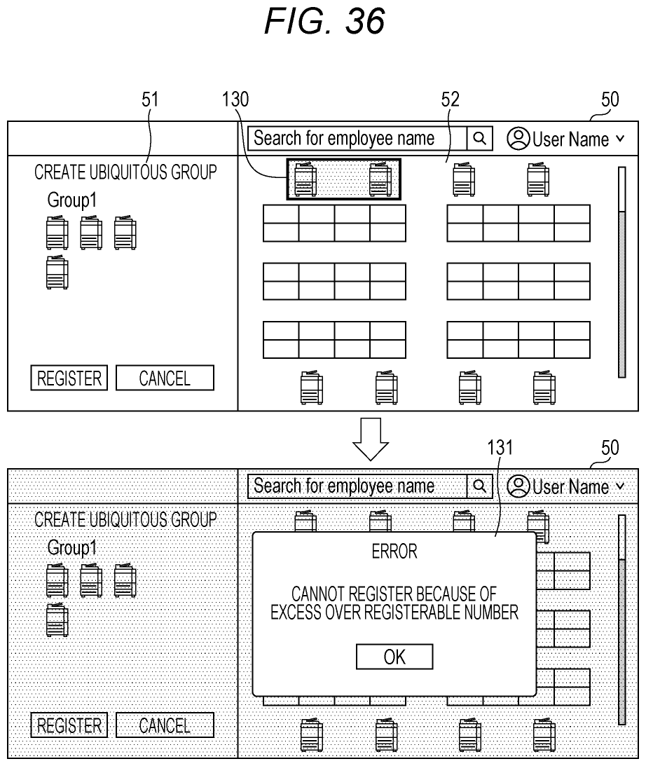

FIG. 36 illustrates an error screen indicating that a new image forming device 10 cannot be registered in the group in a case where the number of image forming devices 10 registered in the group reaches a predetermined number in the image forming system 1.

As illustrated in FIG. 36, in a case of collectively adding a plurality of image forming devices 10 illustrated on the floor map to the group by specifying an area 130, the error screen is displayed in a case where the number reaches the upper limit of the number of image forming devices 10 belonging to the group. In FIG. 36, in a case where the maximum number of image forming devices 10 which may be registered in the group is five, it is determined to be error when it is tried to collectively add two devices while there are already four devices registered, so that an error display window 131 is popped up.

With such a configuration, the number of image forming devices 10 registered in a specific group may be limited, and the load of each group may be distributed.

According to one embodiment described above, the user may operate the terminal device 20 to easily construct the group between the image forming devices 10 installed in close positions.

In addition, after the group construction is completed, the user may easily confirm the role of the image forming device 10 installed in a certain position and the group to which this is set.

In addition, when the image forming device 10 is newly introduced, it is possible to easily consider to which group the image forming device 10 should be added.

Although embodiments of the present invention have been described and illustrated in detail, the disclosed embodiments are made for purposes of illustration and example only and not limitation, and it goes without saying that various other application examples and variations may be taken without departing from the gist of the present invention recited in claims. The scope of the present invention should be interpreted by terms of the appended claims.

For example, the above-described embodiment specifically describes the configuration of the image forming system 1 and each device in detail in order to describe the present invention in an easy-to-understand manner, and is not necessarily limited to that provided with all the described configurations. It is also possible to add other components, delete, or replace the same as for a part of the configuration of the above-described embodiment. Each of the above-described configurations, functions, processors and the like may be realized by hardware by designing a part or all of them with, for example, an integrated circuit.

What is claimed is:

1. An image forming system comprising:
a first image forming device; a second image forming device; a third image forming device; and an information processing device,
wherein the first image forming device saves document data,
the second image forming device acquires a document list indicating document data to present and acquires the document data specified from the document list from the first image forming device to output,
the third image forming device manages the first image forming device, the second image forming device, and the third image forming device as a group, and
the information processing device selects the image forming device allowed to belong to a group from a floor map in which installation positions and device information of a plurality of image forming devices are registered, and associates the information on the selected image forming device with the group to register in the third image forming device.

2. The image forming system according to claim 1,
wherein the information processing device sets whether to prohibit or allow provision of the document list and document output in response to a document acquisition request from the second image forming device belonging to a group different from the group.

3. The image forming system according to claim 1,
wherein the information processing device sets whether to prohibit or allow provision of the document list and document output in response to a document acquisition request from the second image forming device the group to which the device belongs is not yet set.

4. The image forming system according to claim 1,
wherein the information processing device individually selects information indicating the image forming device displayed on the floor map on a group editing screen to register in the group.

5. The image forming system according to claim 1,
wherein the information processing device specifies an area on the floor map of the group editing screen and collectively registers the image forming device present in the specified area in the group.

6. The image forming system according to claim 4,
wherein the information processing device is provided with:
a first selector that selects the information of the image forming device from the floor map; and
a second selector that selects one group from groups registered in advance, and
the image forming device selected by the first selector is additionally registered in the group selected by the second selector.

7. The image forming system according to claim 6,
wherein the information processing device drags and drops the information indicating the image forming device displayed on the floor map of the group editing screen to an arbitrary group displayed in the group display area of the group editing screen, thereby registering the image forming device in the group.

8. The image forming system according to claim 1,
wherein the information processing device further includes a function setter that selects and sets a function to be assigned to the image forming device selected from the floor map.

9. The image forming system according to claim 8,
wherein the function setter selects and assigns a function displayed in a function list to the selected image forming device.

10. The image forming system according to claim 8,
wherein the function setter assigns the function to the image forming device by performing drag-and-drop of the image forming device setting of the function of which is not yet completed selected from the floor map to an area indicating any one of the first image forming device, the second image forming device, and the third image forming device displayed on the group editing screen.

11. The image forming system according to claim 8,
wherein the function setter presents an appropriate function to the image forming device selected from the floor map based on performance of the image forming device.

12. The image forming system according to claim 1,
wherein the information processing device displays information indicating the group to which the image forming device displayed on the floor map belongs on the floor map.

13. The image forming system according to claim 1,
wherein the information processing device disables registration of a new image forming device in the group in a case where the number of image forming devices registered in the group reaches the upper limit number of the group.

14. The image forming system according to claim 1,
wherein the third image forming device has:
a function of transmitting a group configuration list indicating a list of image forming devices included in the group to which the third image forming device belongs to another group; and
a function of transmitting the group configuration list received from the other group to the first image forming device and the second image forming device of its own group.

15. The image forming system according to claim 1,
wherein the first image forming device also serves as the second image forming device.

16. An information processing device that registers an image forming device to a group in an image forming system provided with a first image forming device that saves document data, a second image forming device that acquires a document list indicating the document data to present and acquires the document data specified from the document list from the first image forming device to output, and a third image forming device that manages the first image forming device, the second image forming device, and the third image forming device as a group,
the information processing device selecting the image forming device allowed to belong to the group from a floor map in which installation positions and device information of a plurality of image forming devices are registered and associating the information of the selected image forming device with the group to register in the third image forming device.

17. A group setting method in an image forming system provided with a first image forming device that saves document data, a second image forming device that acquires a document list indicating the document data to present and acquires the document data specified from the document list from the first image forming device to output, and a third image forming device that manages the first image forming device, the second image forming device, and the third image forming device as a group,
the group setting method comprising:
selecting information indicating the image forming device allowed to belong to the group from a floor map in which installation positions and device information of a plurality of image forming devices are registered, and
associating the information of the selected image forming device with the group to register in the third image forming device.
